(19) United States
(12) Patent Application Publication
(10) Pub. No.: US 2006/0092456 A1
(43) Pub. Date: May 4, 2006

(54) Recording medium storing print ordering file, method and apparatus for creating print ordering file

(75) Inventors: Seok Ryu, Suwon-si (KR); Du-il Kim, Suwon-si (KR); Eun-hee Rhim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/198,340

(22) Filed: Aug. 8, 2005

(30) Foreign Application Priority Data
Oct. 29, 2004 (KR) 10-2004-0087057

(51) Int. Cl. G06F 15/00

(52) U.S. Cl. 358/1.15; 358/1.13

(57) ABSTRACT

Provided is a method of printing captured images, a recording medium storing a print ordering file of a captured image including multimedia data, and a method and apparatus for creating the print ordering file. The recording medium includes stored files and a markup language print ordering file created based on selection information selecting the file to be printed among the stored files and print control information on the file to be printed. The stored files include a captured image file, a hypertext file, or a combination thereof. The print ordering file uses an asset ID of the MPV format including a definition of a media asset, or an element or an attribute of an XML format. An image file and a hypertext file including multimedia data can be printed in a variety of forms without print control information restriction.

### CROSS-REFERENCE TO RELATED APPLICATIONS

This application is based upon and claims the benefit of priority from Korean Patent Application No. 10-2004-0087057, filed on Oct. 29, 2004, in the Korean Intellectual Property Office, the disclosure of which is incorporated herein in its entirety by reference.

### BACKGROUND OF THE INVENTION

1. Field of the Invention

The invention relates to the printing of a captured image, and more particularly, to a recording medium storing a print ordering file of a captured image including multimedia data, and a method and apparatus for creating the print ordering file.

2. Description of the Related Art

Capture devices such as digital still cameras (DSC), cellular phones or personal digital assistants (PDA) having embedded digital cameras used to capture a digital image have become very popular. With this popularity, demand for printing of the captured images has also increased. Thus, the capture devices are configured to capture the digital image, store the captured image in a recording medium such as a memory card, and transmit the stored image to a printing device.

More specifically, the stored image is transferred from the captured device to the printing device via an interface such as USB or Bluetooth, or is physically transferred to the print device using a recording medium such as a memory card storing the captured image.

When the print device uses the recording medium, the print device loads an image file into a file system of the printing device to print the image file, or the print device marks an image to be printed among captured images stored in the recording medium. The invention described herein relates to a method of marking an image to be printed among images stored in the recording medium and printing the marked image.

The recording medium such as the memory card marks the image file to be printed, and specifies printing rules for the marked image file in order to print an image without a separate device and present the image file on a screen. Marking the image file to be printed and specifying print rules is referred to as print ordering. A file created by print ordering is referred to as a print ordering file. An example of a print ordering file format is the Digital Photo Order Format (DPOF).

FIG. 1 is a diagram of a conventional method of printing an image file. Referring to FIG. 1, a capture device such as a digital camera captures an image and creates a print ordering file in which print information on the captured image is written according to the DPOF. The created print ordering file and an image file are stored in a removable recording medium such as a memory card of the capture device. Then, the removable recording medium is plugged into a print device in order to print the captured image. Next, the print device reads the print ordering file, construes print information on the image file to be printed, and prints the image according to the construed information. The print device makes a standard print of an image, or an index print of a plurality of images as shown in FIG. 1.

FIGS. 2A and 2B are diagrams of a conventional print ordering format according to the DPOF. FIG. 2A is an example of a print ordering file according to the DPOF, and FIG. 2B illustrates keywords used for the print ordering file. Referring to FIG. 2B, keywords GEN, USR, and PRT indicate information on an entire print system, keywords IMG and CFG indicate information on the characteristics of each image, and a keyword VUQ indicates information defined by a supplier. Referring to FIG. 2A, [JOB] indicates information on an image to be printed in a page unit. Ordering information on an image of a 3rd page is illustrated in FIG. 2A. Ordering information includes an image source file to be printed, and print rules of each image file. A capture device specifies the characteristics of an image to be printed using the keywords and informs the print device of the characteristics.

An image to be printed is selected from among images stored in the removable recording medium such as the memory card, print rules of the selected image are specified, and the print ordering file is created, and the created print ordering file is stored with a specific file name, i.e., /root/misc/print.mrk according to the DPOF as shown in FIG. 2A. When the removable recording medium storing the print ordering file is plugged into the print device, the print device construes the print ordering file stored in a predefined directory, i.e., /root/misc/, and prints the image according to the construed information.

However, the DPOF is only usable for an image file, and cannot be used for multimedia data such as hypertext, which includes combined images and text. Further, as shown in FIG. 2B, a limited number of keywords is used to create the print ordering file, which is restricted to print information desired by a user, thereby reducing flexibility of the print ordering file.

### BRIEF SUMMARY OF THE INVENTION

The invention provides a recording medium storing a print ordering file of a captured image, which includes multimedia data.

The invention also provides a method and apparatus for creating a print ordering file of the captured image, which includes multimedia data.

According to an aspect of the invention, there is provided a recording medium, comprising: stored files; and a markup language print ordering file created based on selection information selecting the file to be printed among the stored files and print control information on the file to be printed.

The stored files may include a captured image file, a hypertext file, or a combination thereof, and the print ordering file is capable of coordinating the printing of any of the captured image file, the hypertext file, or the combination thereof.

The print ordering file may use an asset ID including a definition of media asset of a music photo video (MPV) format.

The print ordering file may use an element or an attribute according to an XML format.

The print ordering file may include marking information on the file to be printed, and print control information on the marked file.

The recording medium may be a removable recording medium that can be attached to and detached from a capture device or a print device, and includes an interface for the capture device and the print device.

According to another aspect of the invention, there is provided a method of creating a print ordering file, comprising: receiving user selection information selecting a file to be printed among stored files, and print control information on the file selected by the user; creating the print ordering file using a markup language based on the received selection information and print control information; and storing the created print ordering file in a recording medium.

According to still another aspect of the invention, there is provided an apparatus for creating a print ordering file, comprising: a user interface receiving user selection information selecting a file to be printed among stored files, and print control information on the file selected by the user; a print ordering file creator creating the print ordering file using a markup language based on the received selection information and print control information; and a storage controller storing the created print ordering file in a recording medium.

The apparatus is a capture device used to capture an image.

The capture device is a digital camera, or a mobile device in which a digital camera is embedded.

According to yet another aspect of the invention, there is provided a print device, comprising: a read unit reading a print ordering file from a recording medium, wherein the recording medium stores files to be printed, a markup print ordering file including marked information on the file to be printed, and print control information on the marked file; a print ordering file construing unit construing the read print ordering file; and a print controller printing the file to be printed according to the construed print ordering file.

### BRIEF DESCRIPTION OF THE DRAWINGS

The above and other features and advantages of the invention will become more apparent by describing in detail exemplary embodiments thereof with reference to the attached drawings in which:

FIG. 1 is a diagram of a conventional method of printing an image file;

FIGS. 2A and 2B are diagrams of a conventional print ordering format according to the DPOF;

FIG. 3 is a diagram of a method of printing an image file and a hypertext file according to an embodiment of the invention;

FIG. 4 is a block diagram of an apparatus for creating a print ordering file according to an embodiment of the invention;

FIGS. 5A and 5B illustrate examples of the apparatus 1 for creating the print ordering file according to an embodiment of the invention;

FIGS. 6A through 6D are diagrams of the print ordering file created according to an embodiment of the invention;

FIGS. 7A and 7B are diagrams of the print ordering file created according to another embodiment of the invention;

FIGS. 8 through 11 are detailed diagrams of the MPV-based print ordering file 32A shown in FIGS. 6A through 6D;

FIGS. 12A and 12B are photographs of a user interface used to create the print ordering file according to an embodiment of the invention;

FIG. 13 is a photograph of hypertext printed using the print ordering file according to an embodiment of the invention; and

FIG. 14 is a flow chart illustrating the method of creating the print ordering file according to an embodiment of the invention.

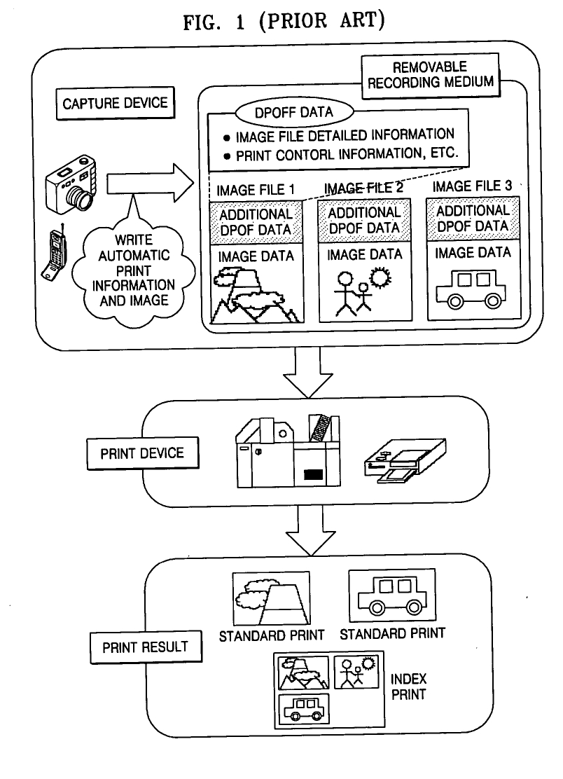

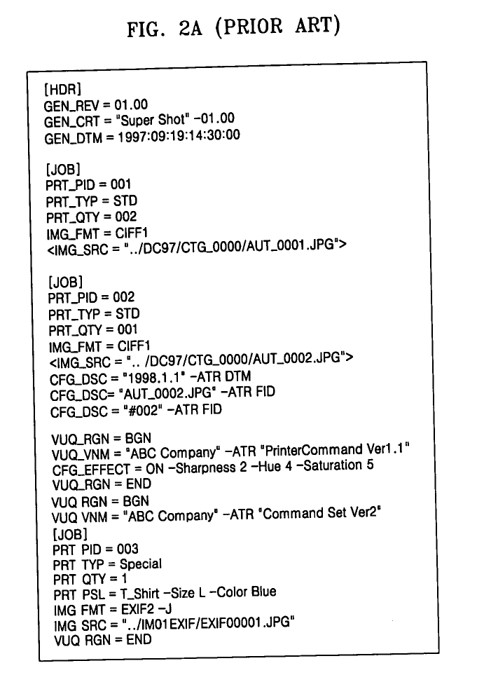

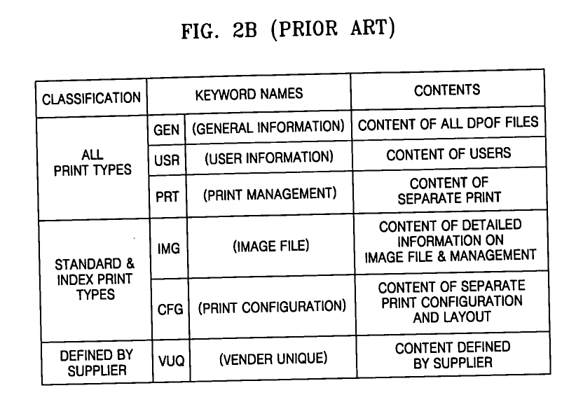

### DETAILED DESCRIPTION OF THE INVENTION

Hereinafter, the invention will be described more fully with reference to the accompanying drawings, in which exemplary embodiments of the invention are shown. The described exemplary embodiments are intended to assist the understanding of the invention, and are not intended to limit the scope of the invention in any way.

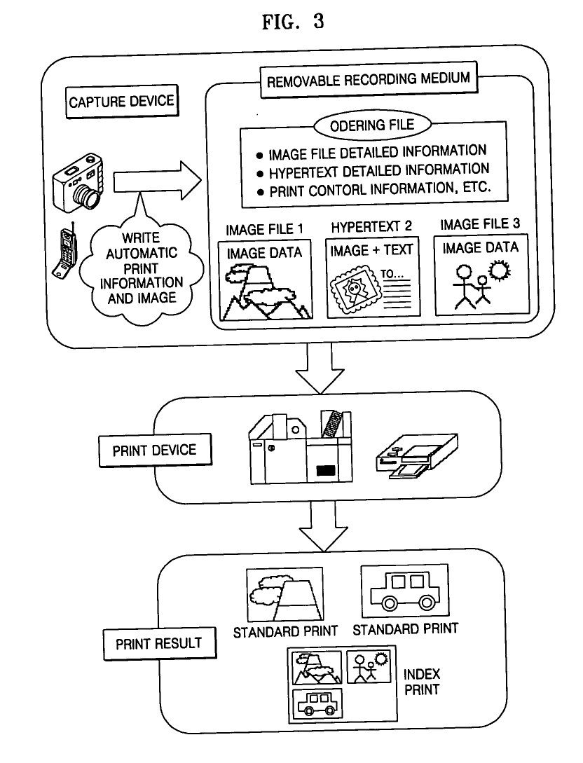

FIG. 3 is a diagram of a method of printing an image file and a hypertext file according to an exemplary embodiment of the invention. Referring to FIG. 3, a capture device creates a print ordering file for the image file and the hypertext file according to the inventive print ordering format, and writes the created print ordering file in a removable recording medium. A print device construes the written print ordering file, and prints a marked image file or hypertext file based on predefined print rules. The format of the print ordering file will be described in detail below.

In contrast to the related art DPOF, the print ordering file herein is used to print the image file and multimedia data such as hypertext as well. More specifically, the print ordering file makes it possible to print an image with a background, an image like an avatar, and an image combined with multimedia information such as a multimedia message service (MMS) for example, a short message service (SMS) or a photo mail or a personal information message service (PIMS).

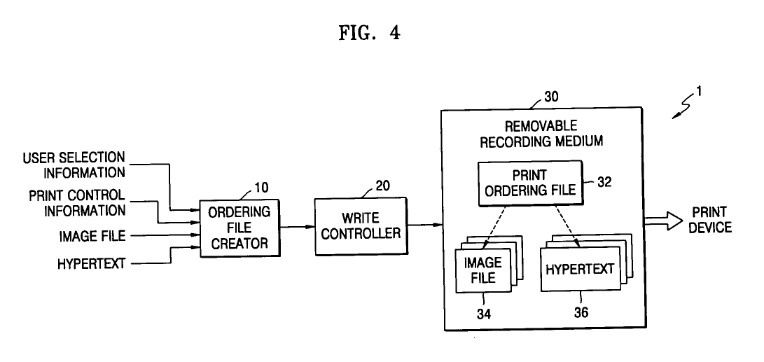

FIG. 4 is a block diagram of an apparatus for creating the print ordering file according to an exemplary embodiment of the invention. Referring to FIG. 4, the apparatus 1 for creating the print ordering file 32 comprises a print ordering file creator 10 and a write controller 20.

The print ordering file creator 10 receives selection information on an image file or a hypertext file to be printed and print control information of each file from a user, and creates the print ordering file 32 based on an image file 34 or a hypertext file 36 among stored image files or hypertext files. The print ordering format will be described in detail later.

The write controller 20 controls the print ordering file 32 to be recorded in a removable recording medium 30 such as a memory card embedded in the apparatus 1 for creating the print ordering file. The print ordering file 32 is based on the image file 34 or the hypertext file 36. When the removable recording medium 30 is plugged into a print device (not shown), the print device prints the image file 34 or the hypertext file 36 based on the written print ordering file 32.

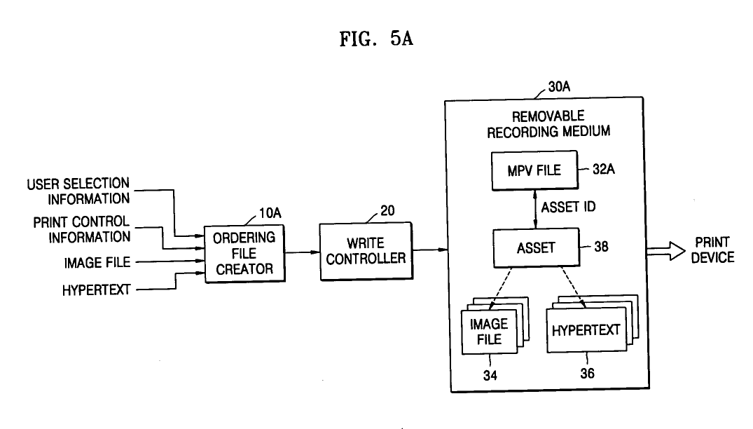

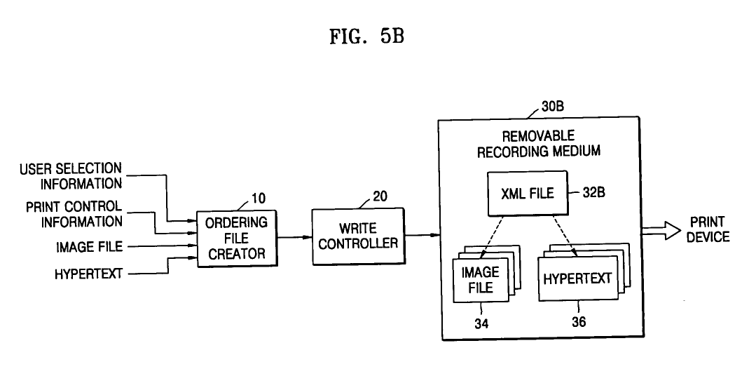

FIG. 5A is a block diagram of the apparatus 1 for creating the print ordering file based on a music photo video (MPV) of the optical storage technology association (OSTA), according to another exemplary embodiment of the invention. A print ordering file creator 10A creates a MPV-based print ordering file 32A in order to designate an image file or a hypertext file to be printed using an ID of an asset according to a MPV format.

Capture devices include consumer electronics (CE) devices such as digital cameras, digital camcorders, and mobile devices having an embedded digital camera. A capture device is used to capture various media such as digital still images, images, and text. Such various media are referred to as assets according to the MPV format. Assets can be divided into simple media assets and complex media assets. Simple media assets include digital still images, videos, digital audio, documents, etc., and complex media assets include digital still images+digital audio, continuously photographed digital still images, panorama photographed digital still images, etc.

The image file 34 or the hypertext file 36 is defined as an asset according to the MPV format. The print ordering file 32A designates the image file 34 or the hypertext file 36 to be printed using each asset ID.

FIG. 5B is a block diagram of the apparatus 1 for creating an XML-based print ordering file according to another exemplary embodiment of the invention. The print ordering file creator 10B creates the XML-based print ordering file 32B in order to designate an image file or a hypertext file to be printed using an element or an attribute of the XML format.

The format of the print ordering file usable in the exemplary embodiments of the invention will now be described in detail.

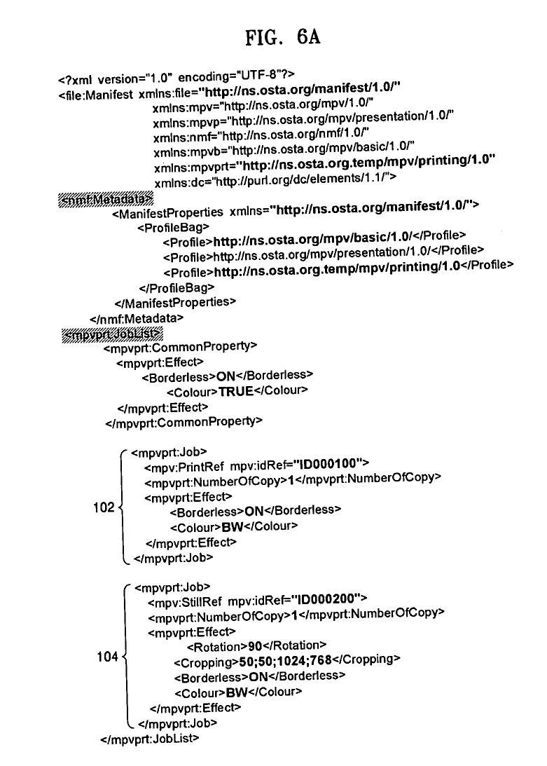

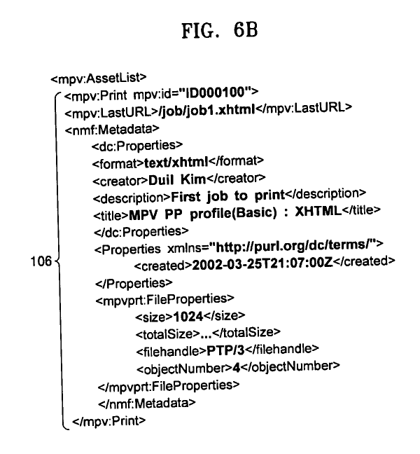

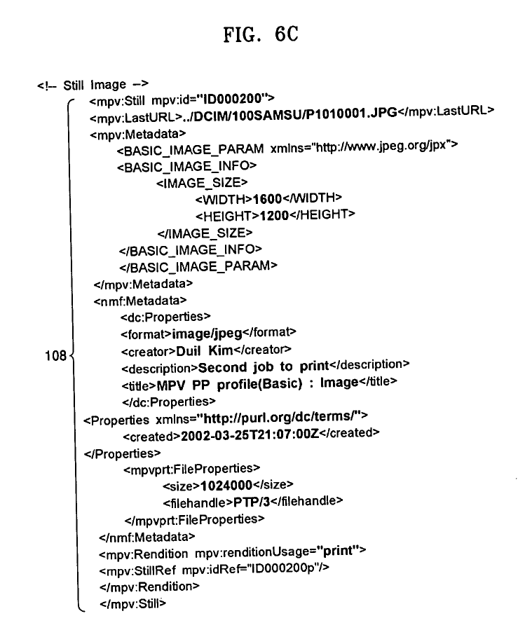

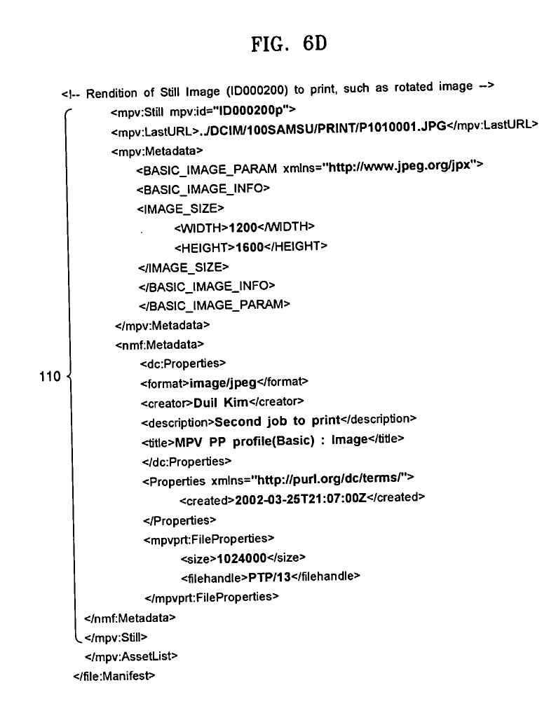

FIGS. 6A through 6D are diagrams of the print ordering file created according to an embodiment of the invention. An example of the MPV-based print ordering file 32A created by the print ordering file creator 10A shown in FIG. 5A is illustrated in FIGS. 6A through 6D. Referring to FIG. 6A, <file:Manifest> defines information on the MPV format, and <mpvptr:JobList> defines print control information on the image file or hypertext file to be printed, and 102 and 104 define print control information of two files. In particular, mpv:idRef=“ID000100” in 102 or mpv:idRef=“ID000200” in 104 designate files to be printed, but do not directly designate an image file or hypertext file. Rather, these elements designate the ID of asset which is defined as the image file or hypertext file to be printed according to the MPV format. That is, the asset ID is used to designate an image file or hypertext file included in an asset. Assets defined using the asset ID are illustrated in 106, 108, and 110 of FIGS. 6B through 6D, respectively. The MPV-based print ordering file will be described in detail later.

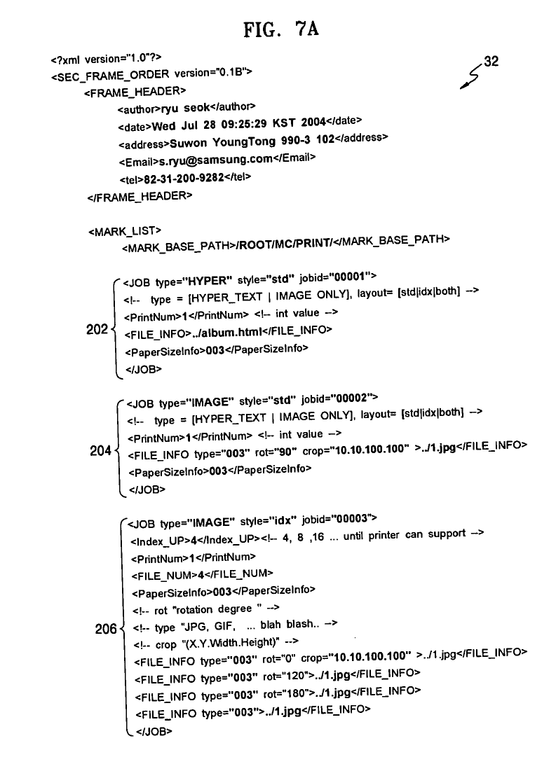

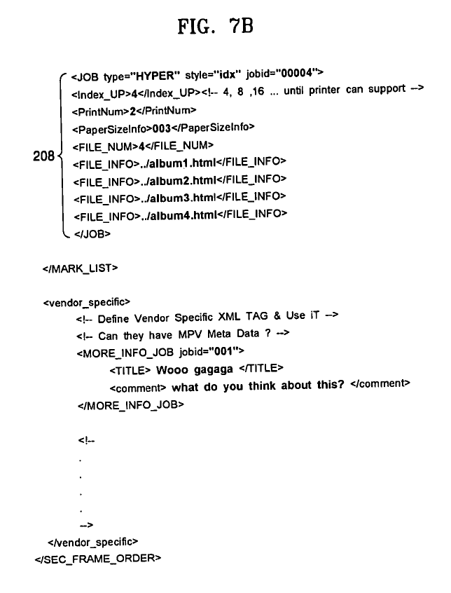

FIGS. 7A and 7B are diagrams of the print ordering file created according to another embodiment of the invention. FIGS. 7A and 7B illustrate examples of the XML-based print ordering file 32B created by the print ordering file creator 10B. A single print ordering file is separately illustrated in FIGS. 7A and 7B for the sake of convenience. Four print ordering jobs 202, 204, 206, and 208 are defined in FIGS. 7A and 7B. A job indicates print ordering information to be printed in the unit of page. Reference numeral 202 defines print control information on a hypertext file, album.html. Reference numeral 204 defines print control information in which a hypertext file 1.jpg is rotated by 90° and printed-. Reference numeral 206 defines print control information in which the hypertext file 1.jpg is rotated by 0°, 120°, and 180° and printed in an index manner. Reference numeral 208 defines print control information in which four hypertext files in the name of album1.html, album2.html, album3.html, and album4.html are printed in the index manner. Lastly, <vendor-specific> defines information provided by a supplier.

In some applications, it is easier to define the print ordering information using the XML-based print ordering file (shown in FIGS. 7A and 7B) than the MPV-based print ordering file (shown in FIGS. 6A through 6D) since the XML-based print ordering file does not follow print rules specified by the MPV format. However, the MPV-based print ordering file (shown in FIGS. 6A through 6D) easily defines print ordering information using assets specified by the MPV format. Thus, the MPV-based print ordering file or the XML-based print ordering file can be selectively used to define the print ordering information according to an applicable environment.

The MPV-based print ordering file will now be described in detail.

FIGS. 8 through 11 are detailed diagrams of the MPV-based print ordering file 32A shown in FIGS. 6A through 6D. FIG. 8 is a diagram of the entire structure of the MPV-based print ordering file 32A. The MPV-based print ordering file 32A comprises a Meta data storing portion 300, a JOB structuring portion 400, and an asset information defining portion 500.

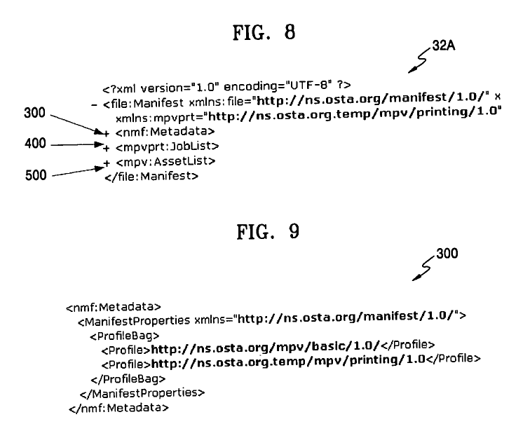

The Meta data storing portion 300 that designates information on the MPV format is illustrated in FIG. 9. Referring to FIG. 9, a basic profile that defines a basic MPV format of the OSTA and a printing profile that defines a printing operation are defined. That is, basic information and print information according to the MPV format are defined.

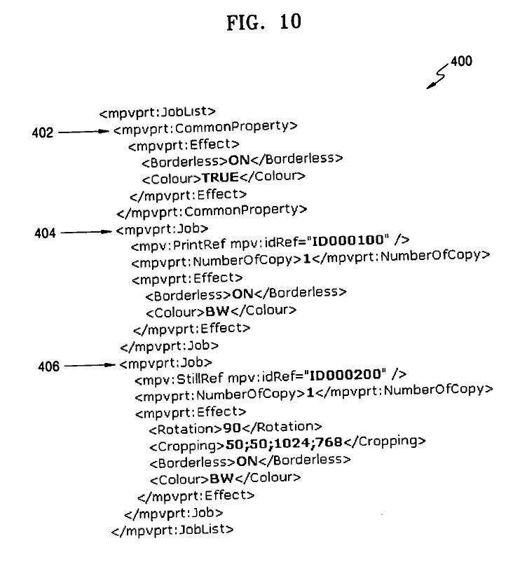

The JOB structuring portion 400 in which JOB is a print unit is illustrated in FIG. 10. Referring to FIG. 10, mpvprt:JobList is defined. JobList designates print control information on the number of files to be copied <mpvprt:NumberOfCopy>, whether a file forms a border <Borderless>, whether the file is in black and white or color <Color>, whether the file is rotated <Rotation>, whether the file is cropped <Cropping>, etc. 406 defines <mpv:StillRef mpv:idRef=“ID000200”/>, so that an image file or hypertext file corresponding to the job defined in the asset information defining portion 500 is print-ordered. The job defined in 406 includes print information in which one copy of an image file or a hypertext file from an asset having an asset ID of ID000200 is printed in black and white after being rotated by 90°, being cropped, and having a border formed around the same. The actual image file or hypertext file can be found in the asset defining portion 500 using the asset ID of ID000200.

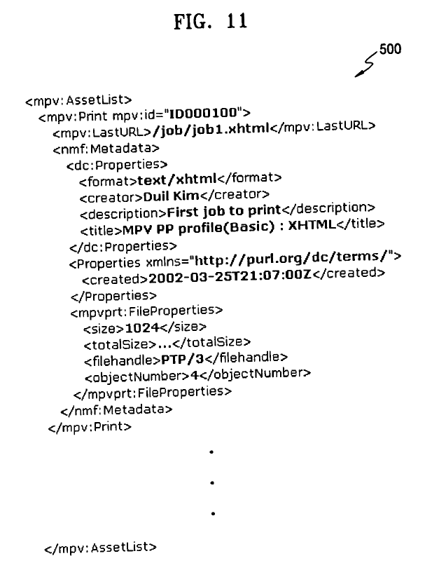

The asset information defining portion 500 that defines the actual image or hypertext file is illustrated in FIG. 11. AssetList is not a new list but a list recommended by the MPV format. Each asset has its own ID, which is used to find the actual image or hypertext file. The asset ID is based on <mpv:StillRef mpv:idRef=“ID000200”/> in the JOB structuring portion 400 in which JOB is a print unit. Referring to FIG. 11, AssetList includes Meta data regarding the basic attributes of an asset. That is, Meta data includes a last URL <mpv:LastURL>, a format <format>, a title <title>, a creator <creator>, property of the actual file <mpv:FileProperties>, and the like.

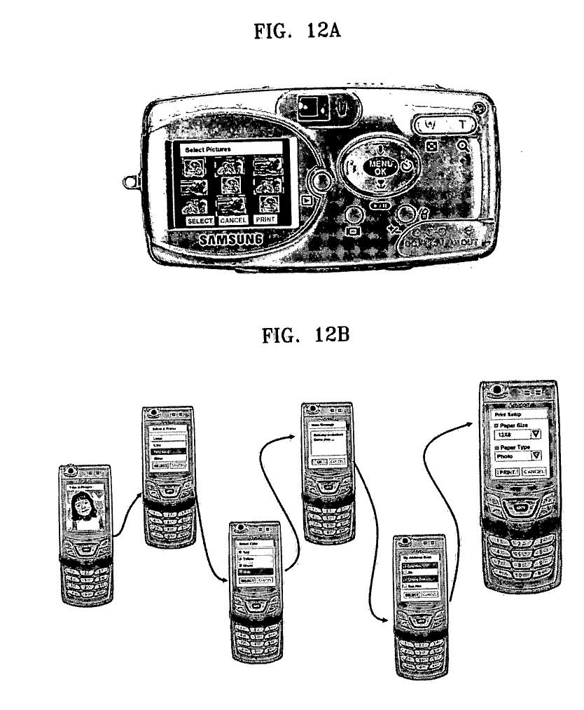

FIGS. 12A and 12B illustrate a user interface used to create the print ordering file according to an embodiment of the invention. The user interface shown in FIGS. 12A and 12B is used to select an image file or a hypertext file, and various print control information such as print format, print layout, paper size, paper type, and text information to be printed.

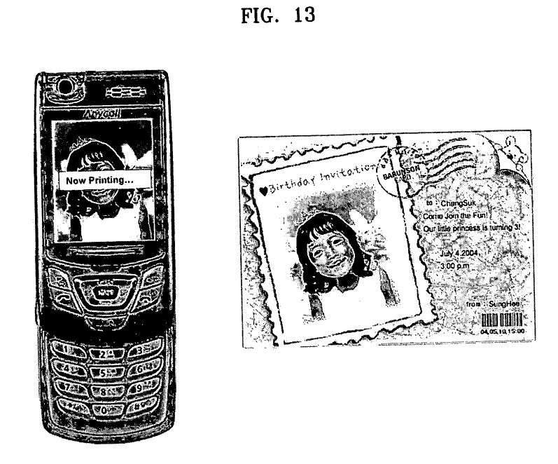

FIG. 13 is an illustration of hypertext printed using the print ordering file according to an embodiment of the invention. The print ordering file is used to print an image file and a hypertext file in a variety of forms according to print control information. Referring to FIG. 13, a congratulation card combined with a captured image and a birthday congratulation message is printed.

Printing of an image file or hypertext file using a print device has been described. However, the print ordering file can also be used to present the image file or hypertext file on a screen.

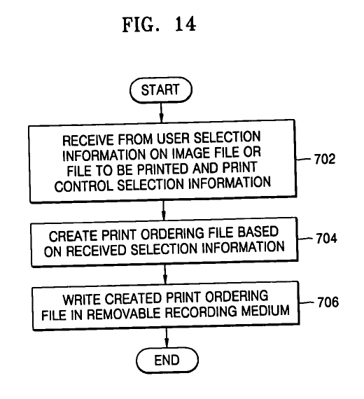

FIG. 14 is a flow chart illustrating a method of creating the print ordering file according to an embodiment of the invention. Referring to FIG. 14, the print ordering file creator 10 receives selection information on an image file or a hypertext file to be printed and print control selection information on the selected file from a user via a user interface (Operation 702). The print ordering file creator 10 creates the MPV-based print ordering file 32A or the XML-based print ordering file 32B based on the received selection information (Operation 704). The write controller 20 writes the print ordering file 32 in the removable recording medium 30 such as the memory card (Operation 706).

When the removable recording medium 30 is installed in a print device, the print device construes the written print ordering file 32, and prints the image file 34 or the hypertext file 36 based on the print control information.

The invention relates to a method of marking the image file or the hypertext file to be printed, creating the MPV-based print ordering file or the XML-based print ordering file based on print control information on the image file or the hypertext file, and storing the created print ordering file in the removable recording medium such as the memory card. The image file or the hypertext file to be printed and print control information on the image file or the hypertext file are selected via the user interface provided by the capture device, and the MPV-based print ordering file 32A shown in FIGS. 6A through 6D or the XML-based print ordering file 32B shown in FIGS. 7A and 7B based on the selection information is created. The created print ordering file is stored in a predetermined location predefined in the removable recording medium. When the removable recording medium is installed in a print device or a display device such as TV or DVD player, the written print ordering file is construed from the predetermined location. The print device prints the image file or the hypertext file based on the construed print control information. The display device displays the image file or the hypertext file on the screen, or prepares the image file or the hypertext file as a DVD. Although it is not shown, the print device comprises a reading unit for reading the print ordering file stored in the removable recording medium, a construing unit for construing the read MPV-based print ordering file or the XML-based print ordering file, and a print controller for printing the marked image file or hypertext file according to print control information based on the construed information.

It is possible for the invention to be realized on a computer-readable recording medium as a computer-readable code. Computer-readable recording mediums include every kind of recording device that stores computer system-readable data. ROMs, RAMs, CD-ROMs, magnetic tapes, floppy discs, optical data storage, etc. are used as a computer-readable recording medium. Computer-readable recording mediums can also be realized in the form of a carrier wave (e.g., transmission through Internet). A functional program, code and code segments, used to implement the invention can be derived by a skilled computer programmer from the description of the invention contained herein.

A recording medium storing a print ordering file of a captured image including multimedia data, a method and apparatus for creating the print ordering file are provided.

An image file and a hypertext file including multimedia data as well can be printed in a variety of forms without print control information restriction.

The MPV-based print ordering file can be created using the asset specified according to the MPV format, while the XML-based print ordering file can be created more easily than the MPV-based print ordering file since the XML-based print ordering file does not follow rules specified according to the MPV format.

While the invention has been particularly shown and described with reference to exemplary embodiments thereof, the invention is not limited to these embodiments. It will be understood by those of ordinary skill in the art that various changes in form and details may be made therein without departing from the spirit and scope of the invention as defined by the following claims.

What is claimed is:

1. A recording medium, comprising:
stored files; and
a markup language print ordering file created based on selection information selecting the file to be printed among the stored files and print control information on the file to be printed

2. The recording medium of claim 1, wherein: the stored files comprise a captured image file, a hypertext file, or a combination thereof; and the print ordering file is capable of coordinating the printing of any of the captured image file, the hypertext file, or the combination thereof.

3. The recording medium of claim 1, wherein the print ordering file uses an asset ID including a definition of media asset of a music photo video (MPV) format.

4. The recording medium of claim 1, wherein the print ordering file uses an element or an attribute according to an XML format

5. The recording medium of claim 1, wherein the print ordering file includes marking information on the file to be printed, and print control information on the marked file.

6. The recording medium of claim 1, wherein the recording medium is a removable recording medium that can be attached to and detached from a capture device or a print device, and includes an interface for the capture device and the print device.

7. A method of creating a print ordering file, comprising:
receiving user selection information selecting a file to be printed among stored files, and print control information on the file selected by the user;
creating the print ordering file using a markup language based on the received selection information and print control information; and
storing the created print ordering file in a recording medium.

8. The method of claim 7, wherein: the stored files comprise a captured image file, a hypertext file, or a combination thereof; and the print ordering file is capable of coordinating the printing of any of the captured image file, the hypertext file, or the combination thereof.

9. The method of claim 7, wherein the print ordering file uses an asset ID including a definition of a media asset according to an MPV format.

10. The method of claim 7, wherein the print ordering file uses an element or an attribute of an XML format

11. The method of claim 7, wherein the print ordering file includes marking information on the file to be printed, and print control information on the marked file.

12. The method of claim 7, wherein the recording medium is a removable recording medium that can be attached to and detached from a capture device or a print device, and includes an interface for the capture device and the print device.

13. An apparatus for creating a print ordering file, comprising:
a user interface receiving user selection information selecting a file to be printed among stored files, and print control information on the file selected by the user;
a print ordering file creator creating the print ordering file using a markup language based on the received selection information and print control information; and
a storage controller storing the created print ordering file in a recording medium.

14. The apparatus of claim 13, wherein: the stored files comprise a captured image file, a hypertext file, or a combination thereof; and the print ordering file is capable of coordinating the printing of any of the captured image file, the hypertext file, or the combination thereof.

15. The apparatus of claim 13, wherein the print ordering file uses an asset ID including a definition of a media asset according to an MPV format.

16. The apparatus of claim 13, wherein the print ordering file uses an element or an attribute of an XML format.

17. The apparatus of claim 13, wherein the print ordering file includes marking information on the file to be printed, and print control information on the marked file.

18. The apparatus of claim 13, wherein the recording medium is a removable recording medium that can be attached to and detached from a capture device or a print device, and includes an interface for the capture device and the print device.

19. The apparatus of claim 13, wherein the apparatus is a capture device used to capture an image.

20. The apparatus of claim 19, wherein the capture device is a digital camera, or a mobile device in which a digital camera is embedded.

21. A print device, comprising:
a read unit reading a print ordering file from a recording medium, wherein the recording medium stores files to be printed, a markup language print ordering file including marked information on the file to be printed, and print control information on the marked file;
a print ordering file construing unit construing the read print ordering file; and
a print controller printing the file to be printed according to the construed print ordering file.

22. The apparatus of claim 21, wherein: the stored files comprise a captured image file, a hypertext file, or a combination thereof; and the print ordering file is capable of coordinating the printing of any of the captured image file, the hypertext file, or the combination thereof.

23. The print device of claim 21, wherein the print ordering file uses an asset ID including a definition of media asset according to an MPV format.

24. The print device of claim 21, wherein the print ordering file uses an element or an attribute according to an XML format.
